(19) United States
(12) Patent Application Publication
(10) Pub. No.: US 2024/0282542 A1
(43) Pub. Date: Aug. 22, 2024

(54) DEVICES AND METHODS INVOLVING SEMICONDUCTING MATERIAL(S) FOR PHOTOCATHODES

(71) Applicant: The Board of Trustees of the Leland Stanford Junior University, Stanford, CA (US)

(72) Inventors: Evan R. Antoniuk, Stanford, CA (US); Bruce Dunham, Stanford, CA (US); Piero Pianetta, Stanford, CA (US); Theodore Vecchione, Stanford, CA (US); Evan J. Reed, Stanford, CA (US)

(21) Appl. No.: 18/570,222

(22) PCT Filed: Jun. 15, 2022
(86) PCT No.: PCT/US2022/033678

§ 371 Date: Dec. 14, 2023

Related U.S. Application Data
(60) Provisional application No. 63/210,884, filed on Jun. 15, 2021.

(51) Int. Cl. H01J 1/34; G06F 30/373; G06F 111/10; G06F 119/08; G06F 119/18; H01J 9/12

(52) U.S. Cl. CPC H01J 1/34; G06F 30/373; H01J 9/12; G06F 2111/10; G06F 2119/08; G06F 2119/18; H01J 2201/3423

(57) ABSTRACT

Among various examples, one is directed to identifying one or more particular photocathode semiconductor structures via a computer-based method. The method includes calculating, for each of a plurality of semiconductor materials and via a database characterizing electronic band structures of respective semiconductor materials corresponding to the plurality of semiconductor materials, an intrinsic emittance score (e.g., using an optimistic selection of a work function) as a predictive screening metric for whether the semiconductor material may exhibit low intrinsic emittance. A subset of the semiconductor materials may be selected, wherein each of the semiconductor materials in the subset satisfies screening criteria based on the intrinsic emittance score, and photocathode brightness properties of said one or more of the semiconductor materials in the subset are characterized, thereby identifying certain semiconductor materials in the subset of the semiconductor materials with desirable photocathode brightness properties.

### FEDERALLY-SPONSORED RESEARCH AND DEVELOPMENT

This invention was made with Government support under contract DE-AC02-76SF00515 awarded by the Department of Energy. The Government has certain rights in the invention.

### BACKGROUND

Aspects of the present disclosure are related generally to photocathodes, photocathode properties and to methods for identifying semiconductor materials that have such properties as are useful for photocathodes.

Over the last ten to fifteen years, nanoscale wavelength and femtosecond timescale x-ray pulses have been generated using tools, such as x-ray free-electron lasers (XFELs), to provide researchers with the first direct observations of atomic-level fundamental processes. As a result of the impressive capabilities and results achieved by these tools, a rapid development of new tools has occurred globally, with the launch of three new facilities in the past three years alone. Relations have been derived that relate the X-ray performance of an XFEL to its electron beam brightness, which is then affected by the transverse momentum spread of electrons at the photocathode. Accordingly, the discovery of novel high brightness photocathode materials is one of the most promising directions for future XFEL performance improvements. Recent simulations of photoinjector brightness demonstrate that identifying novel photocathode materials could increase the brightness of photoinjectors by up to one order of magnitude.

Despite the large potential increase in beam brightness that can be realized from discovering new ultrabright photocathode materials, a relatively small number of photocathode materials have been experimentally explored. The time-intensive and challenging nature of measuring the brightness of photocathode materials has limited experimental studies to less than a few tens of materials out of many thousands of possible candidates.

### SUMMARY OF VARIOUS ASPECTS AND EXAMPLES

Various examples/embodiments presented by the present disclosure are directed to issues such as those addressed above and/or others which may become apparent from the following disclosure.

In one example, the present disclosure concerns a method that includes identifying one or more particular semiconductor photocathode materials. The method includes calculating, for each of a plurality of candidates present in a database characterizing electronic band structures, an intrinsic emittance score as a predictive screening metric for whether the material may exhibit low intrinsic emittance. A subset of the materials may be selected, wherein each of the materials in the subset satisfies screening criteria based on the intrinsic emittance score. Photocathode brightness properties of one or more of the materials in the subset are characterized, thereby identifying materials in the subset with desirable photocathode brightness properties. The intrinsic emittance score may be selected to account for the possible thermalization of excited electrons into the conduction band minimum corresponding to the semiconductor material and/or to account for the transport of electrons to the surface for emission.

In a related more-specific example, a computer-based method is directed to identifying one or more particular photocathode semiconductor structures via a computer-based method. The method includes calculating, for each of a plurality of semiconductor materials and via a database characterizing electronic band structures of respective semiconductor materials corresponding to the plurality of semiconductor materials, an intrinsic emittance score (e.g., using an optimistic selection of a work function or a related parameter) as a predictive screening metric for whether the semiconductor material may exhibit low intrinsic emittance. A subset of the semiconductor materials may be selected, wherein each of the semiconductor materials in the subset satisfies screening criteria based on the intrinsic emittance score, and photocathode brightness properties of said one or more of the semiconductor materials in the subset are characterized, thereby identifying certain semiconductor materials in the subset of the semiconductor materials with photocathode brightness properties. The intrinsic emittance score may be selected to account for the possible thermalization of excited electrons into the conduction band minimum corresponding to the semiconductor material and/or to account for the transport of electrons to the surface for emission.

In certain other examples which may also build on the above-discussed aspects, aspects of the disclosure are directed to filtering at least some of the semiconductor materials by one or more of the following: screening for synthesizability of at least some of the semiconductor materials: screening for air stability and/or thermodynamic stability of certain of the semiconductor materials: screening to identify a family of the semiconductor materials, each of the semiconductor materials in the family exhibiting photoemission properties that correspond, within twenty percent, to multiple photoemission properties of alkali antimonide materials: screening to identify certain of the semiconductor materials characterized as exhibiting intrinsic emittances that are at least as low as 0.30 μm/mm: screening one or more of the semiconductor materials by identifying, for each of said one or more of the semiconductor materials, whether the semiconductor material has spin-polarized band structure; and screening one or more of the semiconductor materials by identifying, for each of said one or more of the semiconductor materials, whether the semiconductor material has a threshold number of atoms in the primitive unit cell and based on said identifying, using the step of screening for elimination based on a corresponding overly complex structure.

In certain other examples which may also build on the above-discussed aspects, methods are directed to: the calculated intrinsic emittance score corresponding to a minimum achievable intrinsic emittance assuming that incident photon energy can be tuned with a precision in a range of incident photon energies (e.g., the range being defined by a precision of 0.10 eV, 0.20 eV, or another precision such as one between 0.05 eV and 0.50 eV); and the selected subset of the semiconductor materials based on testing of one or more of the selected semiconductor materials to confirm that the corresponding intrinsic emittance score, used as a predictive screening metric for whether the semiconductor material may exhibit low intrinsic emittance, actually exhibits a desired minimum level of intrinsic emittance.

In certain other examples which build on certain of the above-discussed aspects, said selecting of a subset of the semiconductor materials includes testing of one or more of the selected semiconductor materials to confirm that the corresponding intrinsic emittance score, used as a predictive screening metric for whether the semiconductor material may exhibit low intrinsic emittance, actually exhibits a desired minimum level of intrinsic emittance, and the method may further include, for each semiconductor material within a certain group of the plurality of semiconductor materials, calculating or evaluating one or more of the following: a work function corresponding to an experimentally observed stable surface termination of the semiconductor material: photoexcitation matrix elements of the semiconductor material; and electronic structural aspects of the semiconductor material using a dense, uniform k-point mesh.

According to other aspects of the present disclosure, a device includes a photocathode, including one or more semiconductor materials (acting as the photocathode) from among the following: BeSe, Li₂Te, ZnTe, ZnSe, MgTe, CdS, Na₂Te, cubic-AlN, wurtzite-AlN, GaP, N₂O, K₂O, and Rb₂O.

In yet other aspects of the present disclosure, a device includes an alkali oxide material acting as the photocathode (e.g., Li₂O, Cs2O, LiNaO, LiKO, LiRbO, LiCsO, NaKO, NaRbO, NaCsO, KRbO, KCsO, and/or RbCsO), and in other aspects a device comprises an alkali telluride material (acting as the photocathode) which does not include Cs (e.g., Na2Te, K2Te, Rb2Te, LiNaTe, LiKTe, LiRbTe, NaKTe, NaRbTe, and/or KRbTe).

In yet further aspects of the present disclosure, a device includes a material from among an alkali pnictogenide materials (acting as the photocathode) and/or a material from among alkali chalcogenide materials (acting as the photocathode).

The above discussion is not intended to describe each aspect, embodiment or every implementation of the present disclosure. The figures and detailed description that follow also exemplify various embodiments.

### BRIEF DESCRIPTION OF FIGURES

Various example embodiments, including experimental examples, may be more completely understood in consideration of the following detailed description in connection with the accompanying drawings, each in accordance with the present disclosure, in which:

FIG. 1 is a screening workflow, according to certain exemplary aspects of the present disclosure;

FIGS. 2A and 2B show, according to certain exemplary aspects of the present disclosure and for a certain semiconductor, plots of band energy against wavevector (first row), related calculated intrinsic emittance plots against photon energy (second row), and keys for interpreting the plots (third row);

FIG. 3 is a chart, according to certain exemplary aspects of the present disclosure, showing distribution of intrinsic emittance scores plotted relative to a number of materials involved in an assessment or screening:

FIGS. 4A and 4B are respectively graphs showing calculated intrinsic emittance scores plotted against excess energy, according to certain exemplary aspects of the present disclosure:

FIG. 5 is another screening workflow, according to certain exemplary aspects of the present disclosure; and

FIG. 6 is a chart, according to certain exemplary aspects of the present disclosure, showing calculated intrinsic emittance scores plotted against electron effective mass.

While various embodiments discussed herein are amenable to modifications and alternative forms, aspects thereof have been shown by way of example in the drawings and will be described in detail. It should be understood, however, that the intention is not to limit the disclosure to the particular embodiments described or materials identified. In addition, the term “example” as used throughout this application is only by way of illustration, and not limitation.

### DETAILED DESCRIPTION

Aspects of the present disclosure are believed to be applicable to a variety of different types of apparatuses, systems and methods involving devices characterized at least in part by selection of one or more particular photocathode materials. While the present disclosure is not necessarily limited to such aspects, an understanding of specific examples in the following description may be understood from discussion in such specific contexts.

Accordingly, in the following description various specific details are set forth to describe specific examples presented herein. It should be apparent to one skilled in the art, however, that one or more other examples and/or variations of these examples may be practiced without all the specific details given below. In other instances, well known features have not been described in detail so as not to obscure the description of the examples herein. For ease of illustration, the same connotation and/or reference numerals may be used in different diagrams to refer to the same elements or additional instances of the same element. Also, although aspects and features may in some cases be described in individual figures, it will be appreciated that features from one figure or embodiment can be combined with features of another figure or embodiment even though the combination is not explicitly shown or explicitly described as a combination. As example, it is appreciated that in many different types of photocathode devices, combinations of different photocathode semiconductor materials may be used and such photocathode semiconductor materials include those discovered herein (e.g., by using examples of the present disclosure), and many applicable photocathode device types, as non-limiting examples, are discussed in the underlying US Provisional Application which is referenced herein.

Exemplary aspects of the present disclosure are directed to identifying one or more particular photocathode semiconductor structures via a computer-based method. In one specific example, the method includes calculating, for each of a plurality of semiconductor materials and via a database characterizing electronic band structures of respective semiconductor materials corresponding to the plurality of semiconductor materials, an intrinsic emittance score (e.g., using an optimistic selection of a work function or a related parameter) as a predictive screening metric for whether the semiconductor material may exhibit low intrinsic emittance. A subset of the semiconductor materials may be selected, wherein each of the semiconductor materials in the subset satisfies screening criteria based on the intrinsic emittance score, and photocathode brightness properties of said one or more of the semiconductor materials in the subset are characterized, thereby identifying certain semiconductor materials in the subset of the semiconductor materials with photocathode brightness properties.

In one particular example according to the present disclosure, a computer-implemented method was used to computationally screen 74,992 inorganic bulk materials to identify novel low emittance photocathode materials. As a result, 2,114 synthesizable, low intrinsic emittance photocathode materials were discovered, thereby validating such methodology for further material discovery efforts. The low emittance materials discovered in this list span a diverse range of chemistries, evidencing that they could not have been discovered as chemical analogues of known photocathode materials. Certain DFT (Density Function Theory) validations on a subset of the discovered materials confirm the estimated low intrinsic emittance in 88% of the tested materials, highlighting the robustness of screening predictions according to examples disclosed herein. Through analyzing 7,981 electronic band structures and 90,698 surface slabs, statistically meaningful insights are provided to guide future development of photocathode materials. Such example screening methods and efforts also result in the identification of at least one family of air-stable visible light photocathodes, as well as ultralow emittance materials with up to four times lower emittance than the current state-of-the-art materials. These discoveries are expected to greatly expand the range of experimental possibilities for photoemitting materials.

In other example embodiments, one or more particular methods may involve different types of screening so as to filter out certain of the semiconductor materials based on criteria. Example screening methodology includes one or more of the following: screening for synthesizability of said at least some of the semiconductor materials: screening for air stability and/or thermodynamic stability of said at least some of the semiconductor materials: screening to identify a family of the semiconductor materials, each of the semiconductor materials in the family exhibiting photoemission properties that correspond, within twenty percent, to multiple photoemission properties of alkali antimonide materials: screening to identify certain of the semiconductor materials characterized as exhibiting intrinsic emittances that are at least as low as 0.30 μm/mm: screening one or more of the semiconductor materials by identifying, for each of said one or more of the semiconductor materials, whether the semiconductor material has spin-polarized band structure; and screening one or more of the semiconductor materials by identifying, for each of said one or more of the semiconductor materials, whether the semiconductor material has a threshold number of atoms in the primitive unit cell and based on said identifying, using the step of screening for elimination based on a corresponding overly complex structure.

Consistent with the above aspects, such methodology may build on the above-discussed aspects by further involving one or more of: the calculated intrinsic emittance score corresponding to a minimum achievable intrinsic emittance assuming that incident photon energy can be tuned with a 0.10 eV precision of incident photon energies; and the selected subset of the semiconductor materials being based on testing of one or more of the selected semiconductor materials to confirm that the corresponding intrinsic emittance score, used as a predictive screening metric for whether the semiconductor material may exhibit low intrinsic emittance, actually exhibits a desired minimum level of intrinsic emittance.

Consistent with the above aspects, such a manufactured device or method of such manufacture may involve aspects presented and claimed in U.S. Provisional Application Ser. No. 63/210,884 filed on Jun. 15, 2021 (STFD.431P1 S21-100) with Appendices, to which priority is claimed. To the extent permitted, such subject matter is incorporated by reference in its entirety generally and to the extent that further aspects and examples (such as experimental and/more-detailed embodiments) may be useful to supplement and/or clarify.

According to certain more specific examples, aspects the present disclosure are directed to one or more particular semiconductive materials for use in a photocathode device. Examples associated with ultra-high brightness include one or more photocathode semiconductor materials from among the following: BeSe, Li₂Te, ZnTe, ZnSe, MgTe, CdS, Na₂Te, cubic-AlN, wurtzite-AlN, and GaP. Other examples associated with air stability include one or more photocathode semiconductor materials from among the following N₂0, K₂O, and Rb₂O.

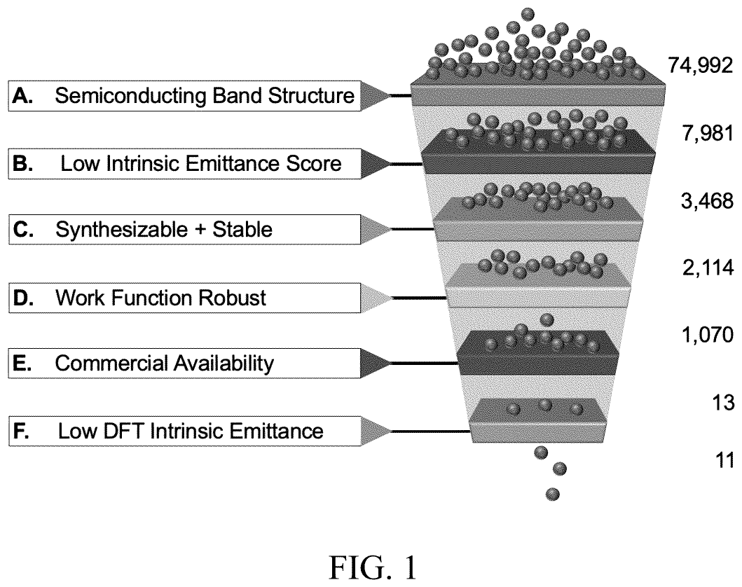

Identifying High Brightness Photoemitting Materials. FIG. 1 illustrates a screening workflow for identifying low intrinsic emittance materials. The column on the right indicates the number of remaining candidate materials after applying each screening criterion. It has been appreciated that in principle, the brightness of an electron beam emitted from a photocathode can be accurately predicted from ab-initio calculations, such as density functional theory (DFT). However, this task is computationally expensive, even for tens of materials. Accordingly, consistent with aspects of the present disclosure, methodology may be used to efficiently screen through tens of thousands of materials by initially utilizing simple, but physically motivated approximations. These initial approximations may be constructed to minimize the number of false negative predictions and avoid filtering out promising candidates in early stages of the screening. This approach therefore identifies an upper limit of all photocathode materials that may be able to achieve high brightness, which then serves as a base for further down-selection with increasingly accurate calculations as in FIG. 1.

Identifying Semiconducting Photocathodes. XFEL photocathodes should have high quantum efficiency (QE), low intrinsic emittance, fast response time, and should be sufficiently stable to allow for sustained operation. Metallic photocathodes such as Cu and Mg are commonly used because of their long operational lifetime, fast response times, ease of synthesis and reasonably low intrinsic emittance. However, the high reflectivity and small electron-electron scattering mean that free path in metals fundamentally limits their possible QE, with a peak QE of 0.3% observed in Mg. Semiconducting alkali antimonide photocathodes such as Na₂KSb and Cs₃Sb were first discovered from pioneering photoemission studies by Sommer in the 1950s and remain among the most popular choice of photocathode materials today, primarily because of their impressively high QE (reaching over 40%) and relatively short response times. However, alkali antimonide semiconductor photocathodes are extremely sensitive to oxidation. They typically require operation under ultra-high vacuum conditions and can experience a degradation in QE, even after a few minutes of operation. Since the QE of metallic photocathodes are typically orders of magnitude less than that of semiconducting photocathodes, exemplary efforts in the present disclosure are focused on identifying a full spectrum of semiconducting photocathode materials.

To begin the screening, reference or identification is made to all (or a subset of) semiconducting materials available on the Materials Project database, a publicly available computational database containing the thermodynamic, structural, and electronic properties of over 120,000 inorganic crystalline materials, as of December 2020. Among these, 74,992 materials have calculated electronic band structures available. In this example, all semiconducting materials are identified (calculated band gap>0 eV) that have less than 20 atoms in the primitive unit cell, resulting in 13,368 unique materials. This example chooses to place a limit on the number of atoms in the primitive unit cell to filter out materials with overly complex structures that may be difficult to synthesize and characterize. This example also eliminates all materials with spin-polarized band structures, since current DFT-based intrinsic emittance models have not been formulated to account for electronic band structures with non-degenerate spin states. These filters result in a list of 7,981 semiconducting materials that this example uses to search for high brightness photocathode materials.

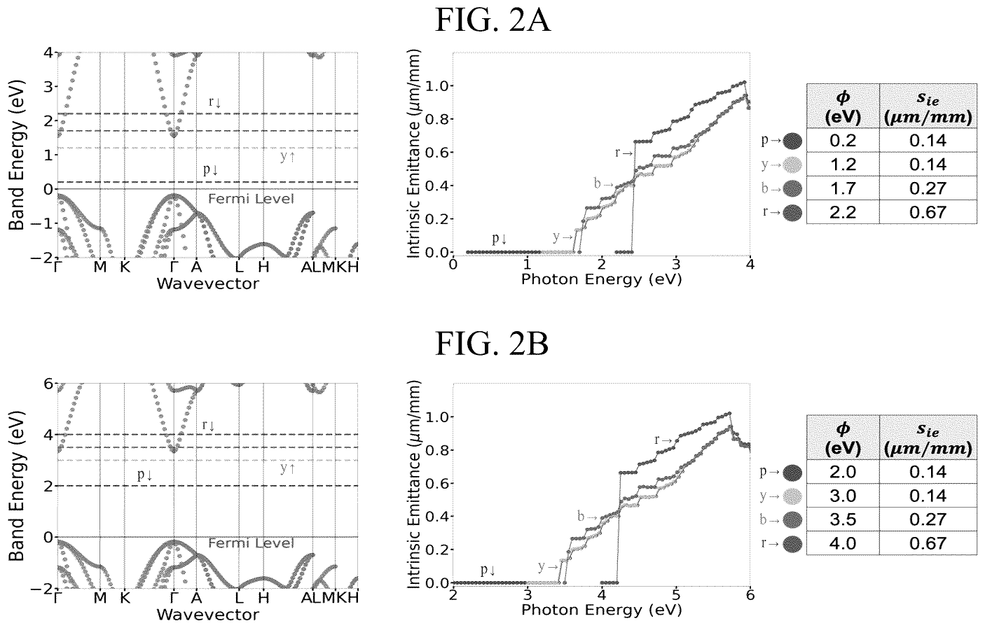

Low Intrinsic Emittance Scores. Intrinsic emittance, εᵢₙₜ, is the standard metric for assessing the brightness that a photocathode material can achieve. If the momentum and position of the photoemitted electrons are uncorrelated, εᵢₙₜ is given by

$${ε}_{int} = \frac{1}{mc} \sqrt{〈 {p}_{x}^{2} 〉} \qquad ( 1 )$$

where m is the electron mass, c is the speed of light, and pₓ is the transverse momentum of electrons emitted from the photocathode material (see Supplementary Note I herein below). During the transmission of electrons across the photocathode-vacuum interface, the transverse momentum of electrons is conserved. Therefore, the distribution of wavevectors in momentum space, as given by electronic band structures, provides a means for estimating the intrinsic emittance of a material. The relationship between the electronic band structure of a material and the intrinsic emittance calculated from that band structure is illustrated in FIGS. 2A-2B. In short, the incident photon energy dictates the states that can undergo optical excitations and the work function of the photocathode sets a lower bound on the energy of the conduction band states that can emit electrons.

Recently, Antoniuk et al. developed a DFT-based framework for calculating the intrinsic emittance of photocathode materials.¹ See, E. R. Antoniuk et al., Phys. Rev. B 2020, 101, 235447. This method is particularly well suited for screening thousands of materials since it does not require any empirical parameters (such as electron effective mass or band gap) as inputs and was developed to be applied to a broad spectrum of photocathode materials. In combination with the recent development of massive databases of calculated electronic band structures, this method enables the accurate determination of the intrinsic emittance for tens of thousands of candidate materials. Additional details regarding this method are given in Supplementary Note 1.

As shown in connection with FIGS. 2A-2B, if all thermal effects are ignored, the intrinsic emittance is zero when the incident photon energy is below the photoemission threshold and typically increases monotonically as a function of photon energy when above the photoemission threshold. Therefore, searching for low emittance materials based on the minimum intrinsic emittance value is unlikely to provide meaningful results. Instead, this example defines a quantity that this example calls the intrinsic emittance score (S_{IE}) to use as a convenient metric for identifying materials that may exhibit low intrinsic emittance. To calculate Sᵢₑ, first the intrinsic emittance values are put into bins, using 0.05 eV intervals, by taking the maximum of each interval. Sᵢₑ is then defined as the lowest non-zero intrinsic emittance value among all of these bins (e.g., as in FIG. S1 of the above-identified US Provisional Application). These examples emphasize that S_{IE} is a predictive and convenient screening metric for identifying low intrinsic emittance materials, but should not be interpreted as a quantity that can be directly compared to experimental measurements. Further validation regarding use of this metric is discussed in the subsection, Deriving Physical Insights from Intrinsic Emittance Scores, and Supplementary Note 2 herein below.

FIGS. 2A and 2B are charts showing calculated intrinsic emittance (εᵢₙₜ) and intrinsic emittance scores (Sᵢₑ) for the prototypical semiconductor, wurtzite-GaN, plotted with various hypothetical work function values(Φ). Left Column: Bulk electronic band structure of wurtzite-GaN obtained from FIG. 2A, the Materials Project database calculated with the PBE functional, and FIG. 2A, the Materials Project with the band gap fit to the experimentally measured band gap of 3.50 eV. Notably, the value of Sᵢₑ does not change for different band gap values in the case of a fixed vacuum level, relative to the conduction band minimum (compare same colored Sᵢₑ values in FIG. 2A and FIG. 2B)) However, the underestimation of the band gap will also lead to an underestimation of the photon energy and work function used or required for low intrinsic emittance. The vacuum level corresponding to different work function values (Ø) are shown as dashed horizontal lines. The work function of 1.2 eV in FIG. 2A corresponds to the value used in screening according to examples disclosed herein. Middle Column: εᵢₙₜ calculated as a function of incident photon energy for various hypothetical work function values. The intrinsic emittance is evaluated with an incident photon energy spacing of 0.05 eV. Right Column: intrinsic emittance score (Sᵢₑ) obtained for each hypothetical work function value.

Since the work function (Φ) of the materials in the database depends on the surface termination of the crystal and is not known a priori, this example initially takes Φ=max (E_{CBM}-0.5 eV, 0 eV), where E_{CBM} is the energy of the conduction band minimum, relative to the Fermi level (Supplementary Note 2). Representing Φ in this way can be considered the most optimistic choice of Φ, since it allows all conduction band states to potentially contribute to photoemission, thus maximizing the number of materials that can have low intrinsic emittance. This optimistic choice of Φ is desirable for an early stage of the screening process because it identifies all materials that have the potential for low emittance. As illustrated in FIG. 2B, assuming a moderate work function of Φ=4.0 eV for GaN in screening (according to examples disclosed herein) would discourage or prevent such examples being used to discover the low intrinsic emittance that is possible at lower values of Φ.

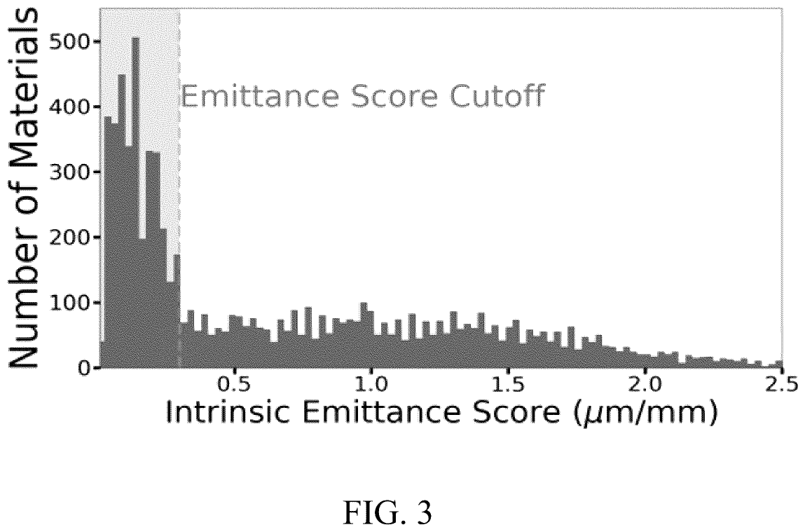

By utilizing these approximations, this example determines the intrinsic emittance score for all 7,981 semiconducting materials that were identified in the subsection which follows, Identifying Semiconducting Photocathodes. The distribution of the results of these calculations are illustrated in FIG. 3. For the purposes of this screening, this example considers a material to have low intrinsic emittance if it has sᵢₑ≤0.3 μm mm⁻¹. For comparison, commonly used Cs₂Te and K₂CsSb photocathodes operate with intrinsic emittances in the range of 0.4-0.6 μm mm⁻¹. Remarkably, in this example it is discovered that 3,468 materials in the database meet this low intrinsic emittance score cutoff. However, this and other examples herein emphasize that this value represents an upper bound to the number of materials with the potential for exhibiting low intrinsic emittance.

FIG. 3 is a chart showing distribution of intrinsic emittance scores (Sᵢₑ) of the 7,981 materials identified in this example effort. For the purpose of this screening, this example classifies a material as having a low intrinsic emittance if Sᵢₑ≤0.3 μm mm⁻¹. This example finds that 3,468 materials in the database meet this low intrinsic emittance criteria.

Synthesizability and Thermodynamic Stability. To ensure the candidate photocathode materials can be readily integrated into photocathode-based devices, materials are filtered out that have not been reported to be synthesized in the literature. This condition is checked by cross-referencing the candidates against the experimental synthesis information provided in the ICSD database. The thermodynamic stability of the candidates may be verified through the energy above the convex hull, Eₕᵤₗₗ, metric provided on the Materials Project database. The energy above the convex hull is defined as the formation energy of a material with respect to the most stable ground state in the chemical space of the material. This and other examples consider a material to be thermodynamically unstable if it has a calculated energy above the hull of Eₕᵤₗₗ>100meV/atom. Although this stability filter could have been applied as discussed under Identifying Semiconducting Photocathodes, in this example a choice is made to apply this filter after calculating the intrinsic emittance scores to allow such examples according to the present disclosure to generate intrinsic emittance data for a broader spectrum of materials. Applying these two filters reduces the 3,468 low intrinsic emittance materials identified in the subsection Low Intrinsic Emittance Scores down to 2,114 materials.

This list of 2,114 materials is noteworthy as it represents a nearly complete list of all synthesizable, bulk, inorganic materials that may exhibit low intrinsic emittance. Despite the very low number of photocathode materials with experimentally measured low intrinsic emittance, this result seems to suggest that low intrinsic emittance may not be a rare property. However, this conclusion is dependent on how well the sᵢₑ metric corresponds to experimentally measured intrinsic emittance values. In particular, this likely represents an upper bound to the number of low intrinsic emittance materials since it assumes a favorable work function value for every material.

It is noted that this list of 2,114 materials contains all of the known low emittance semiconducting photocathode materials that have been reported in the literature to date (Cs₃Sb, K₂CsSb, GaN, GaAs, Cs₂Te), emphasizing the ability of screening, according to examples disclosed herein, to successfully identify promising ultrabright photocathode materials. Although this list contains some chemical analogues of these known photocathode materials, the full spectrum of identified materials is diverse and 98.3% of the materials do not belong to any known family of photocathode materials (see Table S1). It is therefore unlikely that these novel photocathode materials could have been discovered through chemical analogy.

Discovery of Ultralow Emittance Photocathode Materials. In the previous section, example aspects of the present disclosure show how a diverse spectrum of materials can be identified, with these materials having the potential to exhibit low intrinsic emittance under ideal conditions. Next, this example seeks to identify the photocathode materials in the database that can achieve lower intrinsic emittance than the current state-of-the-art photocathode materials when subject to typical FEL operating conditions.

First, identification of photocathode materials is made in the database for those materials that exhibit low intrinsic emittance when illuminated by photon energies between 1-5 eV. This range of photon energies was chosen to match the range of photon energies typically used in photoinjectors (266 nm for Cu and 532 nm for K₂CsSb photocathodes), while also accounting for the consistent underestimation of PBE calculated band gaps. The work function of a material can vary heavily based on the atomic geometry of the surface, the presence of surface contaminants, or external electric fields. To ensure that the candidate photocathode materials are robust against these variations in work function, this example also screens the photocathode candidate materials to ensure that they exhibit low intrinsic emittance across a continuous range of possible work function values of at least 1.0 eV. See Supplementary Note 3 below (see also FIG. S2 of the above-identified US Provisional Application). A total of 1,070 materials satisfy these two criteria.

Next, thirteen (13) materials are identified among these 1,070 materials that are commercially available. By identifying commercially available materials among low emittance candidates according to examples disclosed herein, in this example it is expected that these materials will already have a well understood synthesis, thereby accelerating the experimental realization of these promising materials. For all 13 of these materials, a computing processor circuit may perform accurate DFT calculations of the intrinsic emittance that includes calculating the work function of the experimentally observed stable surface termination, calculating photoexcitation matrix elements, calculating the electronic structure with the HSE06 hybrid functional, and evaluating the electronic structure using a dense, uniform k-point mesh (for further details, see Methods for Details as in the above-referenced US Provisional Application). In these and previous example efforts, it has been shown that intrinsic emittance predictions made from this method agree with experimental measurements with a mean absolute error of 0.044 μm mm⁻¹ across a diverse range of materials. As a means of comparison, this example performs analogous computations for the current state-of-the-art photocathode material, K₂CsSb. Remarkably, 11 out of 13 of these commercially available materials (BeSe, c-AlN, Li₂Te, w-AlN, ZnTe, ZnSe, MgTe, CdS, Na₂Te, GaN and GaP) are discovered to have DFT calculated intrinsic emittance values below 0.30 μm mm-1 when the work function is optimized (see Table S2 below, and see FIG. S4 of the above-identified US Provisional Application). The underestimation of the intrinsic emittance scores of the two misclassified materials (BP and Be₂C) is likely due to the exclusion of low symmetry k-points in the Materials Project band structure (see FIG. S4 of the above-identified US Provisional Application).

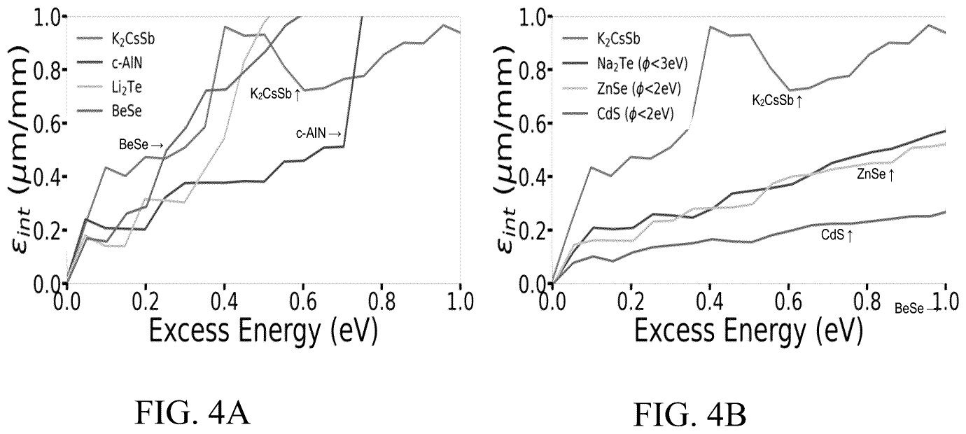

FIGS. 4A and 4B are charts showing DFT calculated intrinsic emittance of representative examples of the ultralow emittance photocathode materials discovered in this work. The DFT calculated intrinsic emittance of the commonly used photocathode, K₂CsSb is shown for comparison. FIG. 4A shows three representative examples of photocathode materials (cubic-AlN, Li₂Te and BeSe) that achieve lower intrinsic emittance than K₂CsSb without requiring work function optimization, and FIG. 4b shows three representative examples of photocathode materials (Na₂Te, ZnSe, and CdS) that achieve ultralow intrinsic emittance when the work function is optimized to the range of values indicated in parentheses.

All eleven materials with low DFT calculated intrinsic emittance are given in Table S2 which follows. The three materials with the lowest predicted intrinsic emittance values are shown in FIG. 4B. For an excess energy of 0.20 eV, DFT predictions according to examples disclosed herein suggest that CdS will exhibit an intrinsic emittance that is an impressive 4x less than that of K₂CsSb. Additionally, this ultralow emittance in CdS is sustained for a broader range of photon energies than for K₂CsSb. However, according to examples disclosed herein predictions indicate that achieving this ultralow emittance in CdS may involve lowering the work function to below 2.0 eV. Similarly, via this example it is predicted that Na₂Te achieves an intrinsic emittance 2× lower than K₂CsSb at an excess energy of 0.2 eV, while only requiring a work function below 3 eV. Additionally, four of the discovered low emittance materials (BeSe, Li₂Te, cubic AlN, and hexagonal AlN) are predicted to exhibit intrinsic emittance values below 0.30 μm mm⁻¹ without requiring any work function optimization as in FIG. 4A.

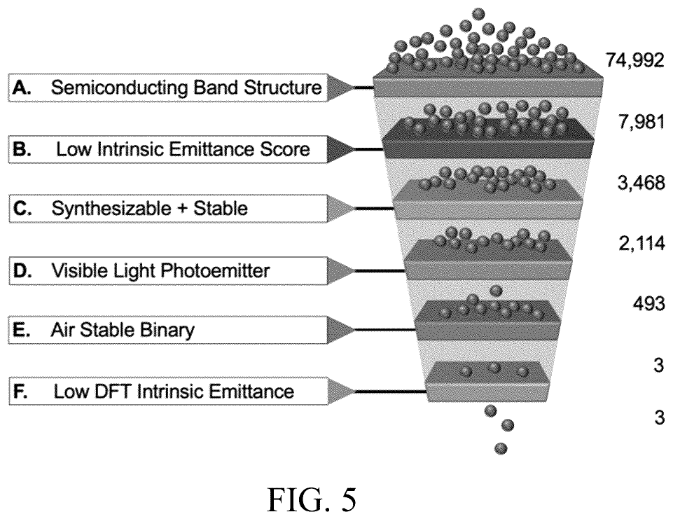

Another workflow example for identification of air-stable visible light photocathodes is presented in FIG. 5. More specifically, FIG. 5 shows an exemplary screening workflow for identifying air-stable visible light photocathode materials. The column on the right indicates the number of remaining candidate materials after applying each screening criteria. Filters A-C are identical to FIG. 1. However, filters D and E identify all air-stable binary materials that have low intrinsic emittance when illuminated by visible light.

Visible Light Photoemitters. Photocathode materials that can operate with visible light driving lasers are preferred since they can be illuminated by the second harmonic of Nd:YAG lasers and can lead to high spatial quality beams. In order to identify photocathodes that exhibit low emittance when illuminated by a visible light laser, this example searches among the 2,114 candidates identified under the subsection herein, Synthesizability and Thermodynamic Stability, for materials that possess a work function below 3 eV, have low intrinsic emittance for photon energies, hω<3 eV, and exhibit low emittance across a 1.0 eV range of work function values. Setting an upper bound on the incident photon energy values for low intrinsic emittance in this step naturally accounts for the consistent underestimation of Materials Project GGA band gaps, thus minimizing the number of false negative material predictions.

In general, the work function of a material is dependent on the most stable Miller index surface termination, as well as the atomic geometry of that termination. For the 2,114 low intrinsic emittance materials identified in the subsection Synthesizability and Thermodynamic Stability, considering all possible surface terminations up to a Miller index of 1 would require an immense 90,698 surfaces, which is an intractable number to evaluate with DFT. Instead, a recently published random forest model for predicting the work function of surfaces is used, as this model has been shown to make predictions with a mean absolute test error of 0.19 eV across a vast chemical space, which is comparable to DFT error. See, P. Schindler. E. R. Antoniuk, G. Cheon, Y. Zhu, E. J. Reed, (Preprint) arXiv: 2011.10905, v1, submitted: November 2020. Ensuring that low emittance is sustained across a 1.0 eV range of possible work function values instills further confidence that predictions, according to examples disclosed herein, are robust against the ±0.19 eV error that is expected in the random forest model work function predictions. With this machine learning approach, efficient calculation of the work function of all 90,698 surface terminations may be realized in a fraction of second per material (for more information in this regard, see Methods section of the above-referenced US Provisional Application).

Applying these three criteria to the 2,114 low intrinsic emittance materials identified in the subsection Synthesizability and Thermodynamic Stability results in the identification of 493 low emittance, visible light photocathode materials (FIG. 5). It is noted that the low work function surface terminations identified here are not checked for thermodynamic stability at this step.

Interestingly, significant correlation (Pearson correlation coefficient, r=0.010) between the minimum work function of a material and its intrinsic emittance (see FIG. S5 of the above-identified US Provisional Application) are not observed, thereby suggesting that these two properties may be able to be independently engineered.

Air Stability. Beyond elucidating all possible low emittance visible light photocathodes, this example now seeks to identify candidate materials that can serve as air-stable replacements for alkali antimonide photocathodes. Computationally, the air stability of a material can be probed through the construction of an oxygen phase diagram. However, this method requires calculating all possible competing phases and neglects the kinetic stability of phases. Instead, this example simply identifies air stable candidate materials by hypothesizing that stable oxide materials will be resistant to oxidation. Although there are a total of 185 oxide-containing materials in a listing of 493 visible light photocathodes, this example only selects for binary, non-radioactive oxides for their ease of characterization and synthesis. This filter results in only three materials: the M₂O (M=Na,K,Rb) anti-fluorite family.

To further assess the photoemission properties of the M₂O family, this example performs detailed DFT calculations to determine the intrinsic emittance for Na₂O, K₂O and Rb₂O. Calculated properties of M₂O and K₂CsSb, according to examples disclosed herein, are well-validated by experimental values previously reported in the literature (see Table 1 which follows) and highlight the exciting potential of the M₂O family as air-stable replacements to alkali antimonide photocathodes. In particular, this example finds that the M₂O family exhibits comparable intrinsic emittance as K₂CsSb as in Table 1 below (see also FIG. S3 of the above-identified US Provisional Application), but with the additional benefit of superior air stability. Although the presence of oxide anions in the M₂O family allows them to be stable against oxidation, their ionic nature is also likely to be responsible for the higher band gap of the M₂O family, relative to K₂CsSb as in Table 1 (see also, FIG. S3 of the above-identified US Provisional Application).

As presented below, Table 1 shows DFT calculated and experimentally measured properties of the newly discovered Na₂O, K₂O and Rb₂O photocathode materials. The equivalent properties for K₂CsSb are shown for comparison. The intrinsic emittance scores (Sᵢₑ) shown here are calculated with the DFT-calculated work function (Φ) of the experimentally observed surface termination, HSE06 electronic band structure, photoexcitation matrix elements, and a dense uniform k-point mesh. For Na₂O, K₂O and Rb₂O, the experimental and DFT work function values are with respect to the alkali-terminated (111) surface. For K₂CsSb, the experimental and DFT work function values are with respect to the Cs-terminated (111) surface.

TABLE 1
(with the asterisk “*” denoting literature-reported findings as at
Ref. Nos. 33-37 of Appendix C of the above-mentioned US Provisional Application):

| | HSE-06 | | | | | | | |
|---|---|---|---|---|---|---|---|---|
| | Band | Literature | Experiment | DFT | Electron | Band | Sᵢₑ | |
| | Gap | Band Gap | Φ | Φ | Effective | Gap | (μm | Air |
| Material | (eV) | (eV) | (eV) | (eV) | Mass (mₑ) | Type | mm⁻¹) | Resistant? |
| Na₂O | 3.26 | — | 1.95* | 2.4 | 0.35 | Direct | 0.23 | Yes |
| K₂O | 2.96 | — | 1.75 | 2.0 | 0.41 | Indirect | 0.19 | Yes |
| Rb₂O | 2.52 | — | 1.2* | 1.1 | 0.36 | Indirect | 0.31 | Yes |
| K₂CsSb | 1.45 | 1.2* | 1.8 | 1.6 | 0.18 | Direct | 0.28 | No |

Discussion of Discovered Photocathode Materials. While there have been numerous reports of the synthesis of Na₂O thin films in the literature, these syntheses typically involve thermally evaporating sodium onto a substrate, followed by controlled oxidation in a dry oxygen atmosphere. Similar reports have been made for Rb₂O and K₂O. Electron diffraction spectra on Na₂O confirm a sodium-terminated (111) surface and subsequent field emission measurements give a work function of 1.95 eV. This measured work function value is in good agreement with DFT predictions according to examples disclosed herein and the measured work function value is well below the 3.2 eV work function for low intrinsic emittance (FIG. S4 of the above-identified US Provisional Application). Additionally, electron momentum spectroscopy (EMS) spectra taken immediately after Na₂O deposition showed no change in electronic band structure after 22 hours of exposure to the EMS electron beam.

These previously reported experimental findings provide convincing validation for the air stability and robustness of Na₂O. Although further experimentation may be pursued to fully assess the lifetime of Na₂O when operated in a photoinjector and the sensitivity towards water vapor, according to examples of the present disclosure, the high air stability of the M₂O family is expected to allow them to be operated in milder vacuum conditions and exhibit longer operational lifetimes than K₂CsSb photocathodes. The discovery of this family therefore paves the way for new photonic devices and applications that are not easily amenable to ultra-high vacuum conditions. If realized, the relaxed vacuum conditions provided by the M₂O family is also expected to greatly simplify the fabrication, synthesis, storage, and transfer of photocathodes.

Among the eleven commercially available, low emittance photocathode materials discovered in this work, four are III-V semiconductors (c-AlN, w-AlN, GaN, GaP). III-V semiconducting materials such as GaN and GaAs have long been considered a promising class of photocathode materials and have demonstrated impressively high quantum efficiencies. This work builds on this knowledge by computationally validating the low intrinsic emittance in these four materials, while also elucidating a complete spectrum of 14 III-V semiconductors that can be expected to exhibit low intrinsic emittance (Table S1).

The other seven materials with low DFT-calculated intrinsic emittance are semiconducting chalcogenides (BeSe, Li₂Te, ZnTe, ZnSe, MgTe, CdS, Na₂Te). Li₂Te and Na₂Te can be considered as chemical analogues of the well-known photocathode material. Cs₂Te. BeSe, ZnTe, ZnSe, MgTe and CdS have all been previously considered in optoelectronic applications as a result of their wide band gap and low effective masses. Interestingly, these properties are also responsible for the low predicted intrinsic emittance values in this work. The electronic properties of these materials have also been extensively studied experimentally. HSE06 predicted band gaps, according to the present disclosure, which agree with experimental bands gaps with a mean absolute error of 0.28 eV, providing experimental validation of the electronic structures used for the intrinsic emittance predictions in this work (Table S2). It is emphasized that all sixteen (16) candidate photocathode materials studied in this work have been previously synthesized and the surface terminations were chosen based on the experimentally stable surfaces of each structure type (see Methods section of the above-referenced US Provisional Application).

Deriving Physical Insights from Intrinsic Emittance Scores. The 16 candidate photocathode materials discovered in this work provide a means to validate the predictive power of the intrinsic emittance scores that this exemplary methodology introduces in an empirical manner. It is found that the intrinsic emittance score metric (Sᵢₑ) is remarkably successful at identifying low intrinsic emittance materials. 14 out of 16 (88%) of the materials with low Sᵢₑ were also found to exhibit low DFT-calculated intrinsic emittance values. As a result of the strong correspondence between Sᵢₑ and DFT-calculated intrinsic emittance values, understanding the physical properties that are correlated with sᵢₑ can provide physical insights into designing low intrinsic emittance photocathode materials.

The most frequently used method for understanding the intrinsic emittance of photocathodes is the model of Dowell-Schmerge, which predicts the intrinsic emittance to scale as εᵢₙₜ∝\sqrt{m*ₑ}, where m*ₑ is the electron effective mass. Owing to this proportional relationship between εᵢₙₜ and \sqrt{m*ₑ}, previous searches for low intrinsic emittance photocathode materials have focused on identifying low electron effective mass materials with direct band gaps. Notably, the Dowell-Schmerge model assumes in its derivation that the electronic structure can be represented by parabolic bands of the form,

$$E ( \vec{k} ) = {E}_{0} + \frac{{( ℏ \vec{k} )}^{2}}{2 {m}_{e}^{*}} ,$$

where m*ₑ is taken to be isotropic. In comparison, the model used in this work employs the full electronic band structure directly, without making any assumptions about its functional form. Plotting Sᵢₑ against m*ₑ therefore allows the methodology of the present disclosure to quantitatively assess how well m*ₑ can be used to predict intrinsic emittance across a broad spectrum of materials.

The dataset as used in the present disclosure provides some evidence that lower electron effective mass materials are more likely to exhibit low intrinsic emittance scores. On average, materials with m*ₑ<0.2mₑ are approximately 1.3× more likely than random (58% vs. 44%) to exhibit low intrinsic emittance scores (see FIGs. S7, S8 and S9 of the above-identified US Provisional Application). Furthermore, the average electron effective mass of the materials with DFT calculated intrinsic emittance values below 0.3 μm mm⁻¹ is 0.26mₑ, which is a lower electron effective mass than 83% of the entire dataset. However, low electron effective mass is not a guarantee for low intrinsic emittance. Even among the materials with a very low electron effective mass of m*ₑ<0.20mₑ, only 58% of these materials exhibit low intrinsic emittance scores. Conversely, 19% of materials with a relatively large electron effective mass of m*ₑ>1.00mₑ also exhibit low intrinsic emittance scores.

In agreement with the intuition that direct band gaps are needed for low emittance photocathodes, it is found that direct band gap materials are approximately 1.5× more likely (59% vs 38%) to exhibit low intrinsic emittance scores than indirect band gap materials (see Table S3 which follows, and FIG. S6 of the above-identified US Provisional Application). Even though direct band gap materials are more likely to exhibit low intrinsic emittance, it is noted that 2,035 indirect band gap materials in the database also exhibit low intrinsic emittance scores. The relative proportion of direct and indirect band gap materials that can exhibit low intrinsic emittance is expected to be affected by the exclusion of phonon scattering in the calculation of sᵢₑ.

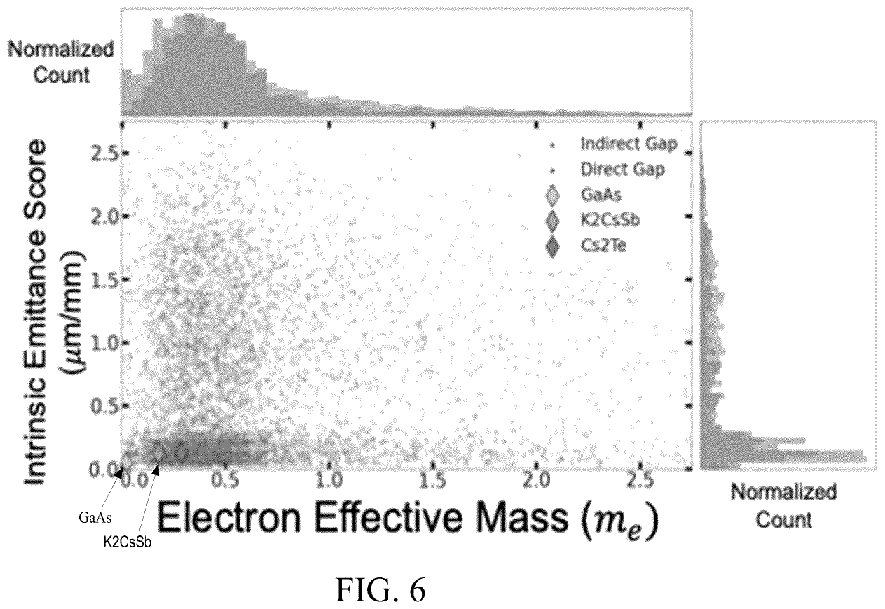

To assess how well m*ₑ values can be used as a predictor for intrinsic emittance scores, a square root relationship is fit between these two quantities (see FIG. S10 of the above-identified US Provisional Application). However, the mean absolute error between this square root law and the calculated intrinsic emittance scores is 0.53 μm mm⁻¹. This result indicates that a very wide range of possible intrinsic emittance scores can exist for a given value of m*ₑ, as is illustrated in FIG. 6. This spread in intrinsic emittance scores may arise due to the presence of degenerate bands, non-parabolic bands and/or anisotropic bands in the electronic band structure, all of which cannot be captured by the electron effective mass parameter.

In summary, low electron effective mass materials are, on average, more likely to exhibit low intrinsic emittance scores. However, it is found that electron effective mass cannot be used as a sole predictor for identifying low intrinsic emittance photocathode materials. Rather, the full electronic band structure may be used to accurately model the intricate relationship between the electronic structure of a material and its intrinsic emittance.

Interestingly, and referring to FIG. 6, it is noted that the well-studied photocathode materials, GaAs, K₂CsSb, and Cs₂Te, exhibit intrinsic emittance scores that are among the lowest in the entire dataset, according to such examples of the present disclosure. Although these materials were discovered through trial-and-error based approaches and with limited data, an understanding of the physics of photoemission has allowed researchers to successfully discover a few of the brightest photocathode materials among hundreds of thousands of possible materials.

FIG. 6. shows calculated intrinsic emittance scores (Sᵢₑ) plotted against the electron effective mass for the 7,981 semiconducting candidate materials in the subsection Low Intrinsic Emittance Scores. Both the intrinsic emittance scores and electron effective mass are calculated from the Materials Project band structures. Materials with direct and indirect band gaps are indicated by blue and gray, respectively, in both the scatter plot and the histogram. Calculated values for the state-of-the-art photocathode materials GaAs, K₂CsSb and Cs₂Te are shown for comparison. All categories shown in the histograms are independently normalized to account for the larger number of indirect gap materials in the database (2,084 direct gap materials and 5,897 indirect gap materials). The electron effective mass of each material is calculated from the curvature of a parabola fit to the 4 k-points on both sides of the conduction band minimum.

Insights into Low Work Function Photocathode Materials. The traditional strategy for achieving low work function materials is to coat the surface of the material with electropositive atoms (typically cesium). This results in a reduced work function due to the build-up of electron density at the surface and the formation of surface dipoles. Here, the ML predicted work functions of 90,698 surfaces are utilized to extend these findings to the problem of identifying low work function (<3 eV) photocathode materials. It is found that among the low work function materials identified in this work, 53.5% contain alkali metals, 31.5% contain alkaline earth metals and 20.6% contain lanthanides (as discussed and identified in FIG. S11 of the above-identified US Provisional Application). On the other hand, it is found only 125 out of the 90,698 surface slabs (0.1%) had work functions below 3 eV and did not contain alkali metals, alkaline earth metals or lanthanides. However, there is also no guarantee that any of these 125 low work function surfaces will be stable.

Although it is known that electropositive atoms achieve a low work function, according to the present disclosure, results suggest that stable <3 eV work function surfaces are exceedingly unlikely to exist for materials without alkali, alkaline earth or lanthanide atoms. Physically, this result may suggest that only alkali, alkaline earth, and lanthanide atoms are sufficiently electropositive to generate a large enough surface dipole for a<3 eV work function material. This important insight greatly reduces the search space for future searches for visible light photocathodes.

Supplementary Note 1: Background on Intrinsic Emittance Calculations. In the following discussion, known methodology (Antoniuk et al.) is used to calculate the intrinsic emittance of all 7,981 semiconducting materials identified in this work. See Photocathodes for High Brightness Photoinjectors, Phys. Procedia 77, 58 (2015). Within this approach, the intrinsic emittance, εᵢₙₜ, is calculated as:

$${ε}_{int} ( ω , T ) = \frac{ℏ}{mc} \sqrt{{\sum }_{i} {w}_{i} ( \vec{k} , ω , T ) {k}_{x , i}^{2}} \qquad ( S1 )$$

where wᵢ represents the relative probability that the i^{th} possible optical transition will result in emitting an electron with wavevector, kₓ. The weight, wᵢ is then calculated as,

$${w}_{i} ( \vec{k} , ω , T ) = \frac{1}{N} {w}_{i , kpt} ( \vec{k} ) \times {w}_{i , opt} ( \vec{k} , ω , T ) \times {w}_{i , escape} ( \vec{k} ) \qquad ( S2 )$$

where N is a normalization factor and w_{i,kpt}( [symbol] ) is the number of symmetry equivalent k-points with the same value of kₓ. w_{i,opt}( [symbol] , ω, T) is the photoexcitation probability of excitation between a final conduction band state, [symbol] , and an initial valence band state, [symbol] , and is given by,

$${w}_{i , opt} ( \vec{k} , ω , T ) = {〈 {ψ}_{\vec{k} , c} \vert \vec{p} \vert {ψ}_{\vec{k} , v} 〉}^{2} \times δ [ {E}_{c} ( \vec{k} ) - {E}_{v} ( \vec{k} ) - ℏω ] \times [ f ( {E}_{v} , T ) - f ( {E}_{c} , T ) ] \qquad ( S3 )$$

where f(E,T) is the Fermi-Dirac distribution of a state with energy, E, and an electronic temperature, T, δ is the Dirac delta function, and [symbol] is the momentum operator of the optical field. w_{i,escape}( [symbol] ) is the probability of the photoexcited electron being emitted from the surface of the photocathode. Since all three of the terms in Equation S2 depend on [symbol] , evaluating w_{i,kpt}( [symbol] ) involves a calculation of the electronic dispersion of the material, E( [symbol] ). Evaluating w_{i,opt}( [symbol] , ω, T) involves an additional calculation of the matrix elements of the photoexcitation, H_{cv}= [symbol] [symbol] | [symbol] | [symbol] [symbol] . Finally, w_{i,escape}( [symbol] ) is then given by,

$${w}_{i , escape} ( \vec{k} ) = \frac{4 {k}_{z , in} {k}_{z , out}}{{( {k}_{z , in} + {k}_{z , out} )}^{2}} \qquad ( S4 )$$

where k_{z,in} is the z-component of the crystal momentum wavevector inside the photocathode and k_{z,out} is the z-component of the wavevector of the emitted electron. k_{z,out} is dependent on the work function of the surface of the photocathode, Φ, through the expression:

$${k}_{z , out} = \sqrt{\frac{2 m}{{ℏ}^{2}} ( E - Φ ) - {k}_{x , out}^{2} - {k}_{y , out}^{2}} \qquad ( S5 )$$

Accordingly, in such example methods disclosed herein, determination of the intrinsic emittance of a photocathode material with Equation S1 may use, at minimum, some representation of Φ, H_{cv}, and E( [symbol] ) of the photocathode material. For more information in this regard, such as a rigorous derivation of these expressions, reference may be made to Antoniuk et al. it is noted that this photoemission model assumes a resonant electron emission process, whereby the emitted electron is assumed to be in the same conduction band state that it was photoexcited into. This photoemission model therefore neglects the thermalization of excited electrons into the conduction band minimum, as well as the transport of electrons to the surface for emission which could be relevant in materials with large skin depths. Additionally, this model assumes that the photoemission is dominated by bulk electronic states, which are expected according to the present disclosure to be valid in materials with skin depths of at least 10 nm.

Supplementary Note 2: Discussion of Intrinsic Emittance Score. In the subsection Low Intrinsic Emittance Scores, a number of approximations are employed to allow Equation S1 to be evaluated with only the data that is available on the Materials Project database. First, it is assumed the photoexcitation matrix elements, H_{cv}, to be unity for all pairs of conduction band states and valence band states. This approximation assumes that all pairs of conduction and valence band states that obey E_{c}( [symbol] )−Eᵥ( [symbol] )=hω will have an equal probability of being excited by a photon of energy, hω. The work function of the photocathode is taken to be Φ=max (E_{CBM}−0.5 eV, 0 eV), where E_{CBM} is the energy of the conduction band minimum, relative to the Fermi level. This choice ensures that the work function is always non-negative, while also ensuring that the work function is not unreasonably small for large band gap materials, leading to better computational efficiency. The choice of taking Φ to be 0.5 eV below the conduction band minimum allows for electrons excited into conduction band minima states to be emitted in the case that k_{x,out} or k_{y,out} are non-zero (Equation S5). Finally, in the subsection Low Intrinsic Emittance Scores, this example represents the electronic dispersion of the material, E( [symbol] ), with the electronic band structures pulled from the Materials Project database. It is assumed a weight of w_{i,kpt}( [symbol] )=1 for every k-point in the electronic band structure. It is also noted that these band structures are calculated with the PBE functional and are expected to underestimate the experimental band gap by approximately 40%, with a mean absolute error of 1.0 eV.^{[31,58]} Following this method, a lifetime broadening of 0.20 eV is used for evaluation of 8 in Equation S3. Also the transverse direction is taken to be along the x-axis.

After employing these approximations, one can then use Equation S2 to calculate εᵢₙₜ (ω). The intrinsic emittance score (S_{IE}) that can be used to identify low intrinsic emittance materials is then calculated from εᵢₙₜ (ω). To calculate S_{IE}, one may bin all non-zero values of εᵢₙₜ (ω) with an interval of 0.05 eV by recording the maximum intrinsic emittance in each bin. The value of S_{IE} is then taken to be the lowest of these binned values (see FIG. S1 of the above-reference US Provisional Application).

Accordingly, one example provides a procedure for calculating sᵢₑ for hypothetical intrinsic emittance data. First, one may determine the maximum intrinsic emittance value for a bin size of 0.05 eV. Sᵢₑ is then the minimum of all of these bins, giving Sᵢₑ=0.26 μm/mm (top) and Sᵢₑ=0.70 μm/mm (bottom). Notably, the binning prevents the εᵢₙₜ=0.10 μm/mm point on the bottom plot to give rise to a low Sᵢₑ. This increases the robustness of screening workflow; according to the present disclosure, by preventing fortuitously low εᵢₙₜ values from giving rise to low intrinsic emittance scores.

Formulating Sᵢₑ in this way provides a number of useful properties that aid in the robust identification of low intrinsic emittance materials. First, the inclusion of the 0.05 eV sliding window ensures that the low emittance materials discovered from screening, according to the present disclosure, are able to exhibit low intrinsic emittance for a range of photon energies, rather than requiring an extremely precise incident photon energy. Additionally, Sᵢₑ is invariant to shifts in the band gap, assuming the vacuum level is located below the conduction band minimum. This allows for accurate identification of low intrinsic emittance materials despite the well-known underestimation of band gaps calculated with the generalized gradient approximation PBE functional. Finally, S_{IE} removes the photon energy dependence of εᵢₙₜ (ω), allowing the photoemission properties of different materials to be directly compared without requiring specification of a particular photon energy.

Due to the proportional relationship between εᵢₙₜ and kₓ² in Equation S1, it is noted that the value of S_{IE} can be limited by the k-point density of the DFT calculation. For example, the smallest non-zero value of kₓ for an electronic structure calculation on a uniform 16×16×16 k-point mesh would be

$$\frac{1}{15} \cdot \frac{π}{a} ,$$

giving the smallest possible non-zero value of εᵢₙₜ to be

$$\frac{ℏ}{mc} \sqrt{{( \frac{π}{15 a} )}^{2}} .$$

For a typical lattice constant of α=5.0 Å, this corresponds to a minimum intrinsic emittance of 0.16 μm/mm. Therefore, for materials with small values of S_{IE}, the value of S_{IE} calculated from Materials Project band structures may be overestimated if it is limited by the k-point density of the band structure calculation. Nevertheless, this effect does not prevent S_{IE} from distinguishing between materials with high intrinsic emittance and low intrinsic emittance.

Supplementary Note 3-Calculating Range of Work Function Values with Low Intrinsic Emittance. To determine the range of hypothetical work function values that can give rise to low intrinsic emittance, one may calculate Sᵢₑ with the method described in Supplementary Note 2. The work function dependence of Sᵢₑ is determined by calculating sᵢₑ with hypothetical work function values ranging from Φ=max(E_{CBM}−0.5 eV, 0 eV) up to Φ+5 eV, with a step size of 0.25 eV. Once the work function dependence of Sᵢₑ (Φ)has been calculated, it is found that the largest continuous range of work function values, Φ, that give Sᵢₑ(Φ)≤0.3 μm/mm (see FIG. S2 of the above-reference US Provisional Application). In examples discussed in the subsections herein, Discovery of Ultralow Emittance Photocathode Materials and Visible Light Photoemitters, screening may be performed for the materials that have a range of work function values that is at least 1.0 eV. This criteria increases the robustness of screening workflow, according to the present disclosure, by ensuring that a low Sᵢₑ value is maintained over a relatively broad range of hypothetical work function values, rather than just the initial hypothetical work function value of Φ=max (E_{CBM}−0.5 eV, 0 eV) used in the subsection Low Intrinsic Emittance Scores. Accordingly, a hypothetical band structure may be used for determining the range of work function values that give sᵢₑ (¢)≤0.3 μm/mm.

Table S1 below shows chemical formulas of the synthesizable, low intrinsic emittance photocathode materials discovered in the subsection Synthesizability and Thermodynamic Stability that belong to known chemical families of photocathode materials. This example considers a material to belong to a family only if all atoms in the formula are represented in the family name. For example, KNaTe is considered an alkali telluride, but KCuTe is not. The remaining 2,078 of the 2,114 materials do not fall into any known family.

TABLE S1

| Known | | # Mate- |
|---|---|---|
| Photocathode | | rials in |
| Family | Materials In Family | Family |
| Alkali | Li₂Te (mp-2530), CsTe (mp-8361), K₂Te (mp- | 11 |
| Tellurides | 1747), Cs₂Te (mp-573763), KTe (mp-2072), | |
| (Cs₂Te) | Rb₂Te (mp-441), CsNaTe (mp-5339), Na₂Te | |
| | (mp-2784), KLiTe (mp-4495), KNaTe (mp- | |
| | 8755), RbTe (mp-8360) | |
| Alkali | Cs₃Sb (mp-10378), Li₃Sb (mp-2074), Rb₃Sb | 11 |
| Antimonides | (mp-16319), RbSb (mp-10487), RbSb (mp- | |
| (Cs₃Sb, | 7444), K₃Sb (mp-10159), NaLi₂Sb (mp-5077), | |
| K₂CsSb) | CsSb (mp-573514), CsK₂Sb (mp-581024), | |
| | KSb (mp-1536), KNa₂Sb (mp-15724) | |
| III-V | AlAs (mp-2172), AlN (mp-1700), GaN (mp- | 14 |
| Semi- | 830), GaP (mp-2490), InN (mp-22205), BP | |
| conductors | (mp-1479), AlSb (mp-1018100), AlSb (mp- | |
| (GaN, GaAs) | 2624), GaSb (mp-1156), GaAs (mp-2534), | |
| | GaSb (mp-1018059), AlGa₃N4 (mp-1019508), | |
| | AlP (mp-1550), InP (mp-966800) | |

As in the above-mentioned US Provisional Application (see, e.g., FIG. S3), calculated intrinsic emittance for K₂CsSb, Na₂O, K₂O and Rb₂O may be plotted against the energy above the photoemission threshold and against the incident photon energy. For all four materials, the work function is calculated with the alkali-terminated (111) surface. For K₂CsSb, the (111) surface is taken to be Cs terminated. The Dowell-Schmerge (DS) model with an electron effective mass of m*ₑ=1.0mₑ is also plotted for comparison.

Table S2 below shows the intrinsic emittance of all materials studied with DFT calculations. The “DFT ϕ” column indicates if the material has low intrinsic emittance (≤0.30 μm/mm) over a 0.05 eV range of incident photon energies is with the DFT calculated work function value (ϕ). The DFT calculated work function value is with respect to the experimentally observed stable surface termination (see also Methods section of the above-referenced U.S. Provisional Application). The “Optimized WF” column indicates if the material has low intrinsic emittance (≤0.30 μm/mm) over a 0.05 eV range of incident photon energies with any work function value. The DFT calculated work function of each material is also given, along with the Miller index and terminating atom of the surface. Band gaps indicated by a * indicate an electronic band gap. Otherwise, experimental and computed band gaps refer to the optical band gap of the material. Electron effective masses are obtained from Materials Project band structures.

TABLE S2

| | | | | | | | Electron |
|---|---|---|---|---|---|---|---|
| | | | | εᵢₙₜ ≤0.30 | HSE06 | Exp. | Effective |
| | | | εᵢₙₜ ≤0.30 | μm/mm | Band | Band | Mass |
| Formula | Structure | DFT ϕ | μm/mm | (Optimized | Gap | Gap | (Exp.) |
| (MP ID) | Type | (eV) | (DFT WF) | WF) | (eV) | (eV) | (mₑ) |
| K₂CsSb | Face- | 1.6 | No | Yes | 1.45 | 1.2[^{36]} | 0.18 |
| (mp-581024) | centered | (Cs, 111) | | | Direct | | |
| | cubic | | | | | | |
| Na₂O | Anti- | 2.4 | Yes | Yes | 3.26 | — | 0.35 |
| (mp-2352) | fluorite | (Na, 111) | | | Direct | | |
| K₂O | Anti- | 2.0 | Yes | Yes | 2.96 | — | 0.41 |
| (mp-971) | fluorite | (K, 111) | | | Indirect | | |
| Rb₂O | Anti- | 1.1 | Yes | Yes | 2.52 | — | 0.36 |
| (mp-1394) | fluorite | (Rb, 111) | | | Indirect | | |
| BP | Zinc | 5.2 | No | No | 2.08* | 2.0*^{[59]} | 1.11 |
| (mp-1479) | blende | (110) | | | Indirect | | |
| BeSe | Zinc | 5.1 | Yes | Yes | 5.15 | 5.55^{[60]} | 0.28 |
| (mp-1541) | blende | (110) | | | Indirect | | |
| Be₂C | Anti- | 2.6 | No | No | 1.91* | 1.9*^{[61]} | 0.24 |
| (mp-1569) | fluorite | (Be, 111) | | | Indirect | | |
| AlN | Zinc | 4.7 | Yes | Yes | 5.35 | 5.34^{[62]} | 0.34 |
| (mp-1700) | blende | (110) | | | Indirect | | |
| Li₂Te | Anti- | 3.4 | Yes | Yes | 3.22 | — | 0.31 |
| (mp-2530) | fluorite | (Li, 111) | | | Indirect | | |
| AlN | Wurtzite | 4.6 | Yes | Yes | 5.41 | 6.12^{[63]} | 0.31 |
| (mp-661) | | (1010) | | | Direct | | |
| ZnTe | Zinc- | 4.7 | No | Yes | 1.95 | 2.26^{[64]} | 0.13 |
| (mp-2176) | blende | (110) | | | Direct | | |
| ZnSe | Zinc- | 4.8 | No | Yes | 2.24 | 2.7^{[65]} | 0.14 |
| (mp-1190) | blende | (110) | | | Direct | | |
| MgTe | Zinc- | 4.7 | No | Yes | 3.09 | ~3.0^{[45]} | — |
| (mp-13033) | blende | (110) | | | Direct | | |
| CdS | Wurtzite | 4.7 | No | Yes | 2.12 | 2.4^{[66]} | 0.17 |
| (mp-672) | | (1010) | | | Direct | | |
| Na₂Te | Anti- | 3.4 | No | Yes | 2.78 | — | 0.24 |
| (mp-2784) | fluorite | (Na, 111) | | | Direct | | |
| GaN | Zinc- | 5.0 | No | Yes | 2.80 | 3.21^{[67]} | 0.19 |
| (mp-830) | blende | (110) | | | Direct | | |
| GaP | Zinc- | 4.6 | No | Yes | 2.36 | 2.74^{[68]} | 0.17 |
| (mp-2490) | blende | (110) | | | Indirect | | |

Comparison of intrinsic emittance predictions may be made using the Materials Project band structures described in the subsection Low Intrinsic Emittance Scores (purple), a PBE calculation with a uniform k-point mesh (yellow) and such PBE calculations shifted to the HSE06 band gap. See, e.g., FIG. S4 of the above-mentioned US Provisional Application. For materials that exhibit low intrinsic emittance only with an optimized work function (Table S2), the intrinsic emittance is plotted over a range of hypothetical work function values to illustrate the potential for low intrinsic emittance. The intrinsic emittance plotted for the hypothetical work function values are calculated with the band structure shifted to the HSE06 band gap. For K₂CsSb, the experimentally measured intrinsic emittance values are shown. The DFT work function may be calculated with respect to be the (111) cation terminated surface for all antifluorite structures, the (110) surface for all zinc blende structures, (101̅0) for all wurtzite structures and Cs-terminated (111) for K₂CsSb.

Intrinsic emittance scores (Sᵢₑ) may be calculated for 2114 low intrinsic emittance materials identified in the subsection Low Intrinsic Emittance Scores. The work function plotted for each material is the minimum work function predicted by the machine learning model over all possible Miller indices up to an index of 1 and all possible termination atoms. A linear fit (y=0.0009x+0.136) to all data points is indicated by the red line and referring to FIG. S5 of the above-referenced US Provisional Application. The Pearson correlation coefficient between the two quantities is 0.010, indicating a lack of significant correlation . . .

Table S3 below shows a number of materials within intrinsic emittance score ranges as shown in FIG. 6. The percentage shown in parentheses is calculated with respect to the number of materials in the “All Materials” row. A total of 215 out of 7,981 materials experienced errors in their high-throughput calculation of intrinsic emittance scores and are omitted here.

TABLE S3

| Intrinsic Emittance | # Direct | # Indirect | |
|---|---|---|---|
| Score | Band Gap | Band Gap | # Total |
| (μm/mm) | Materials | Materials | Materials |
| <0.05 | 79 | 171 | 250 |
| | (3.9%) | (3.0%) | (3.2%) |
| <0.10 | 417 | 675 | 1092 |
| | (20.5%) | (11.8%) | (14.1%) |
| <0.20 | 902 | 1645 | 2547 |
| | (44.4%) | (28.7%) | (32.8%) |
| <0.30 | 1198 | 2222 | 3420 |
| | (59.0%) | (38.7%) | (44.0%) |
| <0.40 | 1283 | 2453 | 3736 |
| | (63.2%) | (42.8%) | (48.1%) |
| <0.50 | 1331 | 2646 | 3977 |
| | (65.6%) | (46.1%) | (40.4%) |
| All Materials | 2030 | 5736 | 7766 |

For related information on such intrinsic emittance estimates, reference may be made to FIGs. S6 and S7 of the above-referenced US Provisional Application. FIG. S6 provides percentage of 7,981 materials identified in the subsection Low Intrinsic Emittance Scores with an intrinsic emittance score below a cutoff value, plotted for indirect and direct band gap materials. FIG. S7 provides percentage of the 7,981 materials identified in the subsection Low Intrinsic Emittance Scores with an intrinsic emittance score below a cutoff value, plotted for multiple electron effective mass ranges. Materials with negative electron effective masses are excluded. FIG. S8 provides percentage of direct band gap materials with an intrinsic emittance score below a cutoff value, plotted for multiple electron effective mass ranges. Materials with negative electron effective masses are excluded. FIG. S9 provides percentage of indirect band gap materials with an intrinsic emittance score below a cutoff value, plotted for multiple electron effective mass ranges. Materials with negative electron effective masses are excluded.

In yet further experimental efforts (e.g., using the above disclosed computer-based methodology), additional photocathode materials were identified as providing excellent brightness and/or air-stability attributes and such materials (alone or in combination with one or more other materials) may be used as an important part of many different types of photocathode-based devices. In certain of these experimental efforts, the photocathode materials include one or more alkali oxide photocathode materials. As examples, the alkali oxide material(s) may include one or more from among the following: Li₂O, Cs₂O, LiNaO, LiKO, LiRbO, LiCsO, NaKO, NaRbO, NaCsO, KRbO, KCsO, and RbCsO (e.g., these materials should be recognized as being stable when exposed to dry air). It is noted that in certain instances, this list of alkali oxide photocathode materials may also include one or more other alkali oxide photocathode materials identified from the set of similar but stoichiometrically unbalanced combinations of the same elements.

In other of these experimental efforts, the photocathode material includes one or more alkali telluride photocathode materials wherein the one or more materials does not include Cs (cesium). As examples, the alkali telluride photocathode material may include one or more from among the following: Na₂Te, K₂Te, Rb₂Te, LiNaTe, LiKTe, LiRbTe, NaKTe, NaRbTe, KRbTe. It is noted that in certain instances, this list of alkali telluride photocathode materials may also include one or more other alkali oxide photocathode materials identified from the set of similar but stoichiometrically unbalanced combinations of the same elements.

In yet further such experimental efforts, the photocathode material includes an alkali pnictogenide photocathodes may be identified from the following explanation. There are thirty five stoichiometrically balanced combinations possible for each X in {N, P, As, Sb, Bi}. This totals 210 possible combinations, not counting the infinite subset of similar but stoichiometrically unbalanced combinations of the same elements. This is an extension of a photocathode, including one or more photocathode semiconductor materials from among the following: N₂0. K₂0, and Rb₂0. Examples include one or more of the following: Li3-X, Na₃—X, K₃—X, Rb₃—X, Cs₃—X, Li2Na—X, Li2K-X, Li2Rb—X, Li2Cs—X, Na₂K—X, Na₂Rb—X, Na₂Cs—X, K₂Rb—X, K₂Cs—X, Rb₂Cs—X, LiNa2-X, LiNaK—X, LiNaRb—X, LiNaCs—X, LiK2-X, LiKRb—X, LiKCs—X, LiRb2-X, LiRbCs—X, LiCs2-X, NaK2-X, NaKRb—X, NaKCs—X, NaRb2-X, NaRbCs—X, NaCs2-X, KRb2-X, KRbCs—X, KCs2-X, RbCs2-X. To the extent that certain of the Sb compounds are previously known as photocathodes, the total possible combinations discovered by way of the above-described methodology of the present disclosure is reduced by removing Sb from X and thereby reducing the overall count by thirty five.

In yet further such experimental efforts, the photocathode material includes an alkali chalcogenide photocathode. There are fifteen stoichiometrically balanced combinations possible for each X in {S, Se, Te}. This totals forty-five possible combinations, not counting the infinite subset of similar but stoichiometrically unbalanced combinations of the same elements. This is an extension of a photocathode including one or more semiconductor materials (acting as the photocathode) from among BeSe, Li2Te, ZnTe, ZnSe, MgTe, CdS, Na2Te, cubic-AlN, and wurtzite-AlN. Examples include: Li2-X, Na2-X, K2-X, Rb2-X, Cs2-X, LiNa—X, LiK—X, LiRb—X, LiCs—X, NaK—X, NaRb—X, NaCs—X, KRb—X, KCs—X, and RbCs—X. To the extent that certain of the Te compounds are previously known as photocathodes, the total possible combinations discovered by way of the above-described methodology of the present disclosure is reduced by removing Te from X and thereby reducing the overall count by fifteen.

Accordingly, many different types of processes and devices using photocathodes may be advantaged by such aspects, the above aspects and examples as well as others (including the related examples, methodology and supplementary figures as in the above-identified U.S. Provisional Application (STFD.431P1)).

It is recognized and appreciated that as specific examples, the above-characterized figures and discussion are provided to help illustrate certain aspects (and advantages in some instances) which may be used in the manufacture of such structures, devices and materials (e.g., as identifiable with reference to the period table). These structures and devices include the exemplary structures, devices and materials described in connection with each of the figures as well as other devices, as each such described embodiment has one or more related aspects which may be modified and/or combined with the other such devices and examples as described hereinabove may also be found in the Appendices of the above-referenced Provisional.

The skilled artisan would also recognize various terminology as used in the present disclosure by way of their plain meaning. As examples, the Specification may describe and/or illustrates aspects useful for implementing the examples by way of various semiconductor materials/circuits which may be illustrated as or using terms such as layers, blocks, modules, device, system, unit, controller, and/or other circuit-type depictions. Also, in connection with such descriptions, the term “source” may refer to source and/or drain interchangeably in the case of a transistor structure. Such semiconductor and/or semiconductive materials (including portions of semiconductor structure) and circuit elements and/or related circuitry may be used together with other elements to exemplify how certain examples may be carried out in the form or structures, steps, functions, operations, activities, etc. It would also be appreciated that terms to exemplify orientation, such as upper/lower, left/right, top/bottom and above/below, may be used herein to refer to relative positions of elements as shown in the figures. It should be understood that the terminology is used for notational convenience only and that in actual use the disclosed structures may be oriented different from the orientation shown in the figures. Thus, the terms should not be construed in a limiting manner.

Based upon the above discussion and illustrations, those skilled in the art will readily recognize that various modifications and changes may be made to the various embodiments without strictly following the exemplary embodiments and applications illustrated and described herein. For example, methods as exemplified in the figures may involve steps carried out in various orders, with one or more aspects of the embodiments herein retained, or may involve fewer or more steps. Such modifications do not depart from the true spirit and scope of various aspects of the disclosure, including aspects set forth in the claims.

1. A method comprising:
calculating, for each of a plurality of semiconductor materials and via a computing processor circuit and a database characterizing electronic band structures of respective semiconductor materials corresponding to the plurality of semiconductor materials, an intrinsic emittance score as a predictive screening metric for whether the semiconductor material may exhibit low intrinsic emittance, wherein the predictive screening metric is based on an optimistic selection of a work function and/or at least one parameter to account for at least one of a possible thermalization of excited electrons into a conduction band minimum corresponding to the semiconductor material and a possible transport of electrons to the surface for emission;
selecting a subset of the semiconductor materials for which each of the semiconductor materials in the subset satisfies screening criteria based on the intrinsic emittance score;
characterizing photocathode brightness properties of one or more of the semiconductor materials in the subset of the semiconductor materials, and thereby identifying certain semiconductor materials in the subset of the semiconductor materials with photocathode brightness properties; and
causing said one or more of the semiconductor materials to emit electrons in accordance with the characterized brightness properties.

2. The method of claim 1, further including using a photocathode, which includes said one or more of the semiconductor materials, by illuminating the photocathode for causing said one or more of the semiconductor materials to emit electrons in accordance with the characterized brightness properties.

3. The method of claim 1, further including screening at least some of the semiconductor materials in the subset to assess at least one of: synthesizability of said at least some of the semiconductor materials; and thermodynamic stability of said at least one of the semiconductor materials.

4. (canceled)

5. The method of claim 1, further including screening at least some of the semiconductor materials in the subset to assess air stability of said at least some of the semiconductor materials.

6. The method of claim 1, further including screening to identify at least one of: a family of the semiconductor materials, each of the semiconductor materials in the family exhibiting photoemission properties that correspond, within twenty percent, to multiple photoemission properties of alkali antimonide materials; and certain of the semiconductor materials characterized as exhibiting intrinsic emittances that are at least as low as 0.30 μm/mm.

7. (canceled)

8. The method of claim 1, wherein the calculated intrinsic emittance score corresponds to a minimum achievable intrinsic emittance with that incident photon energy being tunable with a precision in a range of incident photon energies.

9. The method of claim 8, wherein the range is in a range from 0.05 eV to 0.50 eV.

10. The method of claim 1, wherein the selecting of a subset of the semiconductor materials includes testing of one or more of the selected semiconductor materials to confirm that the corresponding intrinsic emittance score, used as a predictive screening metric for whether the semiconductor material may exhibit low intrinsic emittance, actually exhibits a desired minimum level of intrinsic emittance.

11. The method of claim 1, wherein the selecting of a subset of the semiconductor materials includes testing of one or more of the selected semiconductor materials to confirm that the corresponding intrinsic emittance score, used as a predictive screening metric for whether the semiconductor material may exhibit low intrinsic emittance, actually exhibits a desired minimum level of intrinsic emittance.

12. The method of claim 1, further including screening one or more of the semiconductor materials by a step of identifying, for each of said one or more of the semiconductor materials, whether the semiconductor material has at least one of: a threshold number of atoms in the primitive unit cell and based on said step of identifying indicating one more undesired ones of the semiconductor materials based on a criteria corresponding overly complex structure; and a spin-polarized band structure.

13. (canceled)

14. The method of claim 1, wherein the predictive screening metric is based on an optimistic selection of at least one of following to account for a transportation of electrons to the surface for emission: a parameter to account for thermalization of excited electrons into the conduction band minimum corresponding to the semiconductor material; and a work function to account for thermalization of excited electrons into the conduction band minimum corresponding to the semiconductor material.

15. (canceled)

16. The method of claim 1, further including, for certain of the plurality of semiconductor materials, approximating an estimated work function based on a conduction band minimum corresponding to the semiconductor material, and wherein said at least one parameter includes the estimated work function.

17. The method of claim 1, further including, for each semiconductor material within a certain group of the plurality of semiconductor materials, calculating or evaluating one or more of the following: a work function corresponding to an experimentally observed stable surface termination of the semiconductor material; photoexcitation matrix elements of the semiconductor material; and electronic structural aspects of the semiconductor material using a dense, uniform k-point mesh.

18. (canceled)

19. (canceled)

20. A device comprising:
at least one semiconductor material configured to act as a photocathode and including one or more from among the following: an alkali oxide photocathode material, an alkali telluride material that does not include Cs; and one or more photocathode semiconductor materials from among the following: N₂0, K₂0, and Rb₂0;
and BeSe, Li2Te, ZnTe, ZnSe, MgTe, CdS, Na₂Te, cubic-AlN, and wurtzite-AlN.

21. The device of claim 20, wherein said at least one semiconductor material includes the alkali oxide material, which in turn includes one or more from among the following: Li₂O, Cs₂O, LiNaO, LiKO, LiRbO, LiCsO, NaKO, NaRbO, NaCsO, KRbO, KCsO, RbCsO.

22. (canceled)

23. The device of claim 20, wherein the at least one semiconductor material is the alkali telluride material and the alkali telluride material includes one or more from among the following: Na₂Te, K₂Te, Rb₂Te, LiNaTe, LiKTe, LiRbTe, NaKTe, NaRbTe, KRbTe.

24. The method of claim 1, further including using a photocathode, which includes said one or more of the semiconductor materials, by illuminating the photocathode and causing said one or more of the semiconductor materials to emit electrons in accordance with the characterized brightness properties, and wherein the calculated intrinsic emittance score corresponds to a minimum achievable intrinsic emittance with incident photon energy being tunable with a precision in a range of incident photon energies, and the range is in a range from 0.05 eV to 0.50 eV.

25. A method comprising:
using a photonic device having a photocathode that includes a semiconductor material, from among one or more semiconductor materials of the photocathode, characterized by an intrinsic emittance score that corresponds to and is indicated by at least one of:
an optimized work function of the semiconductor material; and
at least one parameter to account for the semiconductor material manifesting one or more of: a thermalization of excited electrons into a conduction band minimum corresponding to the semiconductor material, and a transport of electrons to a surface of the semiconductor material for emission.

26. The method of claim 25, wherein said at least one parameter is to account for the semiconductor material manifesting each of: a thermalization of excited electrons into a conduction band minimum corresponding to the semiconductor material, and a transport of electrons to a surface of the semiconductor material for emission.

27. The method of claim 25, wherein the semiconductor material of the photocathode includes at least one from among: an alkali oxide photocathode material, an alkali telluride material that does not include Cs; and one or more photocathode semiconductor materials from among the following: N₂0, K₂O, and Rb₂0; and BeSe, Li2Te, ZnTe, ZnSe, MgTe, CdS, Na₂Te, cubic-emittance score, and wurtzite-AlN.

28. The method of claim 25, wherein the semiconductor material does not include any of the following: Cs₂Te, BeSe, ZnTe, ZnSe, MgTe and CdS.
